(19) United States
(12) Patent Application Publication
(10) Pub. No.: US 2007/0252978 A1
(43) Pub. Date: Nov. 1, 2007

(54) Method and Apparatus for Optical Spectroscopy

(75) Inventors: Marjolein Van Der Voort, Valekenswaard (NL); Gerhardus Wilhelmus Lucassen, Eindhoven (NL); Gerwin Jan Puppels, Rotterdam (NL); Michael Cornelis Van Beek, Eindhoven (NL); Coen Theodorus Hubertus Fransiscus Liedenbaum, Oss (NL)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS NV, Eindhoven (NL)

(21) Appl. No.: 10/596,501

(22) PCT Filed: Dec. 13, 2004
(86) PCT No.: PCT/IB04/52771

§ 371 Date: Mar. 13, 2007

(30) Foreign Application Priority Data
Dec. 16, 2003 (EP) 03104718.6

(51) Int. Cl. G01J 3/44; G01J 3/00

(52) U.S. Cl. 356/301; 356/300

(57) ABSTRACT

The present invention provides for a method of optical spectroscopy, in particular Raman spectroscopy for performing invasive or non-invasive blood analysis. The fluorescence component of return radiation which is received from a detection volume is eliminated which is enabled by the usage of a pulsed excitation light source. The pulse length is substantially shorter than the fluorescence life time Hence, the elimination of the fluorescence composent can be performed by time gating or by other electronics or optical means.

The present invention relates to the field of optical spectroscopy, and more particularly without limitation to Raman spectroscopy.

Various methods of optical spectroscopy are known from the prior art. This includes (i) infra-red spectroscopy, in particular infra-red absorption spectroscopy, Fourier transform infra-red (FTIR) spectroscopy and near infra-red (NIR) diffuse reflection spectroscopy, (ii) other scattering spectroscopy techniques, in particular Raman and reflectance spectroscopy, and (iii) other spectroscopic techniques such as photo-acoustic spectroscopy, polarimetry and pump-probe spectroscopy.

One of the problems associated with these prior art spectroscopic techniques is fluorescence which decreases the signal to noise ratio. In particular this is a problem for Raman spectroscopy. For example, a number of 10⁸ photons in the excitation light beam results in a number of 10³ fluorescence photons and only one Raman photon. It is therefore difficult to extract the Raman signal information from the return radiation signal containing the fluorescence.

WO 00/02479 deals with this problem. This document shows a non-invasive glucose monitor which uses Raman spectroscopy. The spectroscopic analysis is performed by collecting two spectra at different excitation wavelengths. Both spectra contain Raman and fluorescence signal. The difference spectrum contains the first derivative of the Raman spectrum without any contribution of fluorescence signal. The blood level of the analyte of interest, i.e. glucose, is determined from the difference spectrum using linear or non-linear multi-variate analysis. This approach is however computationally expensive and requires a laser with a variable output wavelength.

The method of WO 00/02479 is based on so-called frequency modulation. A spectrum, containing Raman and fluorescence signal is collected at two slightly different laser wavelengths. Because the Raman signal shifts with the excitation wavelength, whereas the fluorescence signal does not shift, the fluorescence can be eliminated by subtracting these spectra. This is a standard method in optical spectroscopy.

The present invention provides for a method of optical spectroscopy which uses an excitation light pulse having a first pulse duration. The exitation light pulse causes a return radiation signal that has a first signal component having a second pulse duration that is substantially similar to the first pulse duration. For example, the first signal component is a Raman signal component or another signal component that is caused by an elastic scattering mechanism. In addition the return radiation signal has one or more other signal components, such as luminescence, in particular fluorescence, signal components, and/or background radiation. These other signal components have a longer duration than the first and second pulse duration.

The first signal component carries the information that is used for the spectroscopic analysis. As the pulse duration of the first signal component is about the same as the pulse duration of the exitation light pulse this knowledge of the first pulse duration can be used in order to reduce the second signal component in the return radiation signal.

In accordance with a preferred embodiment of the invention time gating is used in order to reduce the contribution of the second signal component to the return radiation signal. In this embodiment the return radiation signal is only received during a time window corresponding to the length of the first signal pulse. This way the signal to noise ratio is substantially increased.

In accordance with a further preferred embodiment of the invention a part of the return radiation signal is delayed and inverted, and the delayed return radiation signal is added to the undelayed return radiation signal. The negative portion of the resulting signal basically contains information on the first signal component. Hence, filtering out the negative component has the effect of increasing the signal to noise ratio of the first signal component that carries the useful information.

In accordance with a further preferred embodiment of the invention a sequence of exitation pulses is directed onto the detection volume with a certain repetition frequency. A frequency selective amplifier, such as a lock-in amplifier, is used that is tuned to the same frequency. This embodiment is based on the assumption that the second signal components have a much lower frequency than the first signal component.

In essence the invention is based on the concept that a part of the return radiation signal has a pulse duration similar to the duration of the exitation pulse. Typically the return radiation signal will also have a luminescence or fluorescence signal component that has a pulse duration similar to the luminescence/fluorescence lifetime. The difference in duration of the useful signal (first signal component) and unwanted signals (described before as ‘other signal components’) enables to reduce or eliminate the luminescence component in the time domain.

Elimination of the fluorescence component can be performed by delaying part of the return radiation signal, preferably for a time being longer than the pulse duration but smaller than the fluorescence life time. The undelayed return radiation signal and the delayed return radiation signal are subtracted which eliminates or at least reduces the fluorescence component of the return radiation signal.

In accordance with a further preferred embodiment of the invention the undelayed return radiation signal and the delayed return radiation signal are added to provide a first signal. Further, a second signal is provided as follows: first, the undelayed return radiation signal and the delayed return radiation signal are added. Then, the resulting signal is inverted at a moment after arrival of the first signal component. Preferably, this inversion takes place after a time being longer than the excitation pulse duration but smaller than the fluorescence life time. The first and second signals are added which provides a resulting signal with no fluorescence component or at least a substantially reduced fluorescence component.

In accordance with a further preferred embodiment of the invention the light source which provides the excitation light pulses is optically coupled to signal processing electronics in order to provide a time reference for the elimination of the fluorescence component by the signal processing electronics.

In accordance with a further preferred embodiment of the invention the optical coupling of the light source to the signal processing electronics is accomplished by photon counting electronics which also serves for receiving of the return radiation.

In accordance with a further preferred embodiment of the invention the delayed return radiation signal is obtained by optical means. Alternatively the delay of the return radiation signal is provided by electronic means.

Another substantial advantage of the present invention is that it can substantially improve the performance of non-invasive blood analysis for dark or black skin types.

The term “elimination” as used in this document does also encompass a substantial reduction of the fluorescence component in the return radiation rather than complete elimination.

In the following preferred embodiments of the invention will be described in greater detail by making reference to the drawings in which:

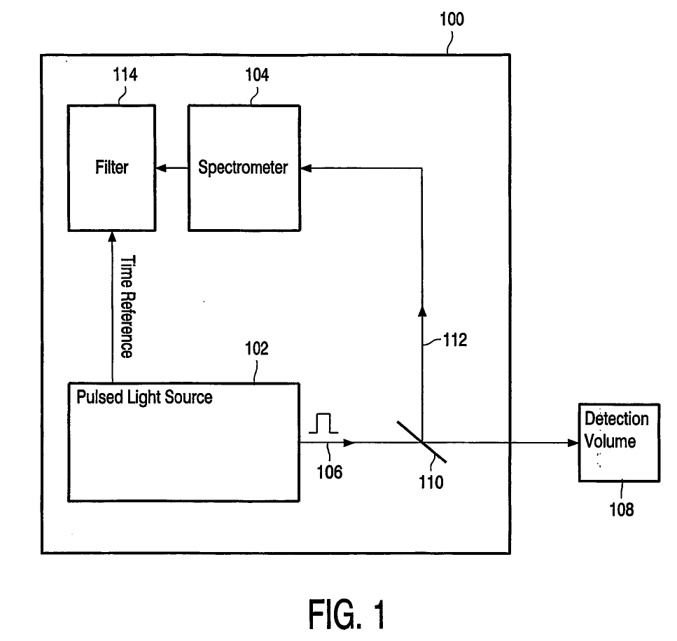

FIG. 1 is a block diagram of an embodiment of a spectroscopic apparatus of the invention,

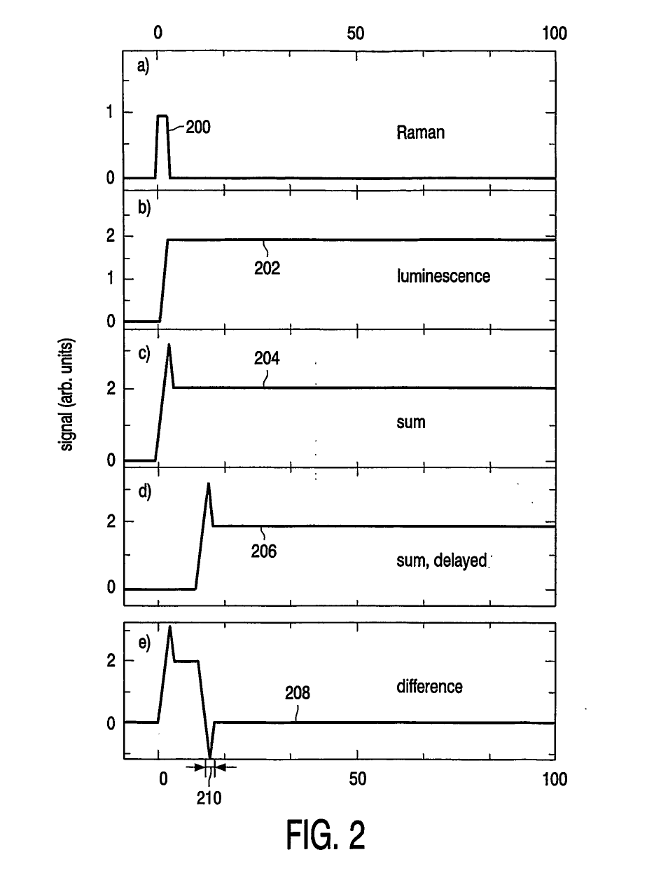

FIG. 2 shows signal diagrams being illustrative of the elimination of the fluorescence component,

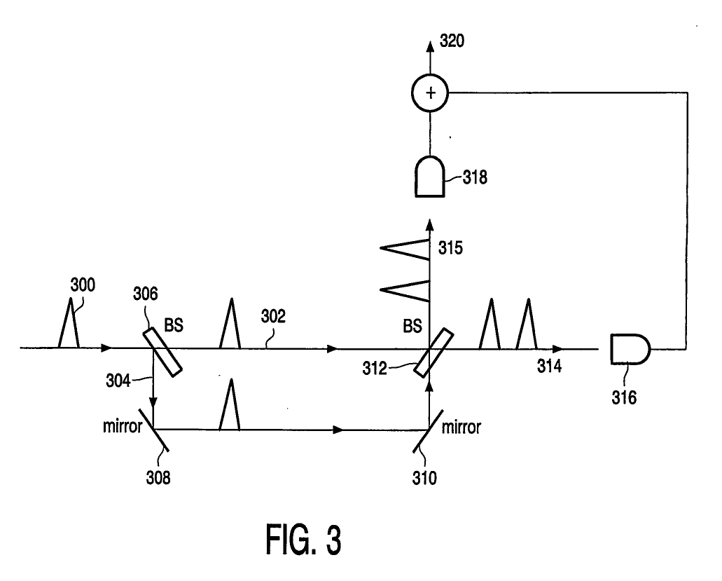

FIG. 3 is illustrative of an optical method for providing a delayed return radiation signal,

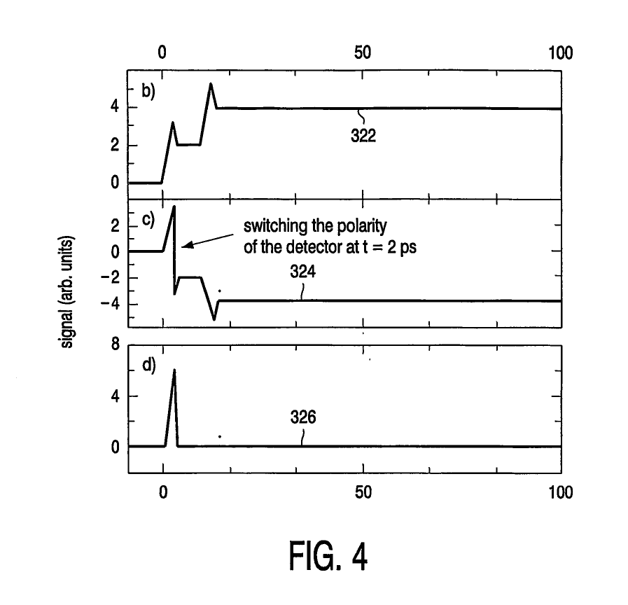

FIG. 4 shows signal diagrams illustrating an alternative method for elimination of the fluorescence component,

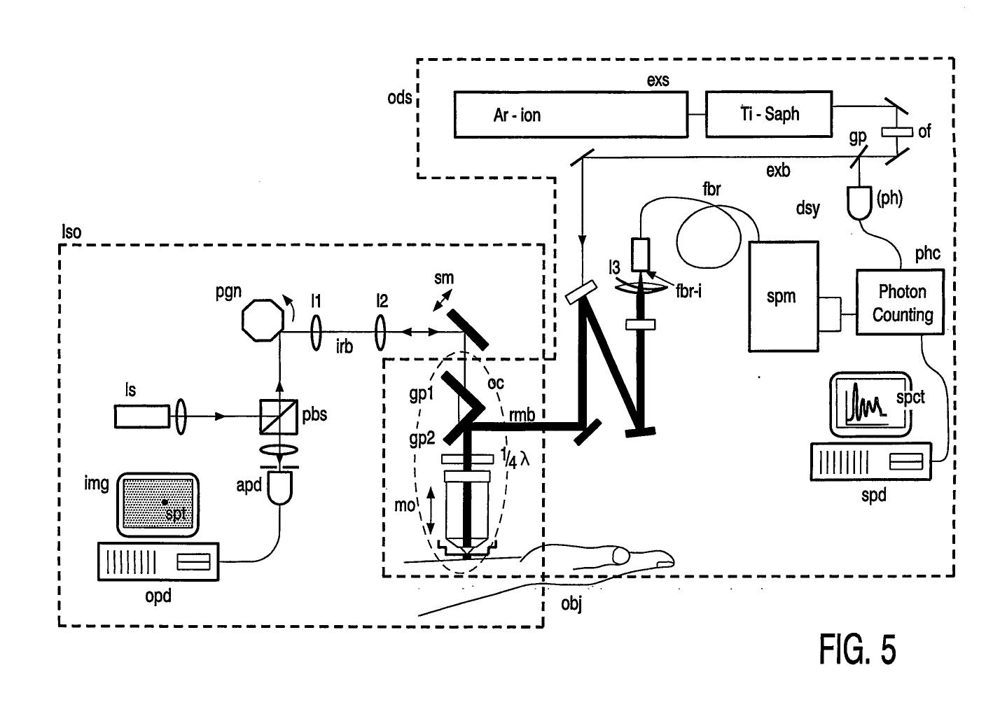

FIG. 5 shows a more detailed embodiment of a spectroscopic apparatus of the invention,

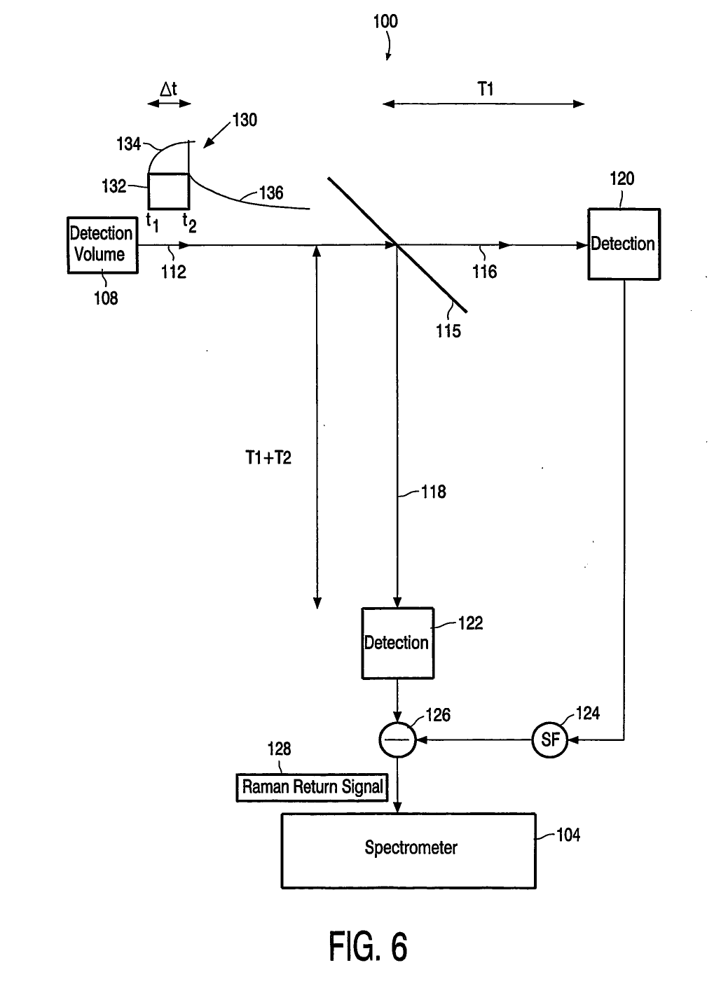

FIG. 6 shows a block diagram of an alternative embodiment using an optical delay in order to improve the signal to noise ratio,

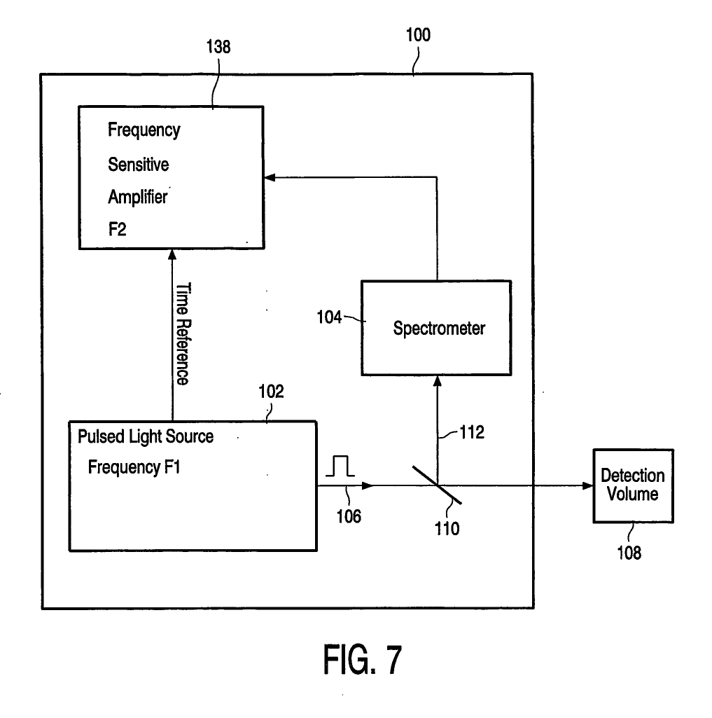

FIG. 7 shows a block diagram of an alternative embodiment using a frequency sensitive amplifier.

FIG. 1 shows apparatus 100 which has pulsed light source 102 and spectrometer 104. Light source 102 provides a sequence of excitation light pulses which are directed towards detection volume 108. Detection volume 108 can be located within a patients body, such as in a blood vessel for performing blood analysis. This can be done in an invasive or in a non-invasive way. For example the excitation light pulses 106 can be guided to detection volume 108 by means of an optical fibre which has a distal end in a catheter head.

By means of dichroic mirror 110 radiation which is returned from detection volume 108 is directed towards spectrometer 104.

Light source 102 is coupled to spectrometer 104 by optical and/or electronic means in order to provide a time reference to spectrometer 104 indicating the timing of the excitation light pulses 106. The duration of the light pulses is substantially below the fluorescence life time, such as two pico seconds.

As a consequence the fluorescence component of the return radiation 112 can be approximated as a constant value for times substantially shorter than the luminescence lifetime after the pulse duration. After spectrometer 104 filter 114 is used to filter out the fluorescence component of the return radiation 112 using the time reference provided by light source 102 and the approximation, that the fluorescence component is about constant. This way the signal to noise ratio of the return radiation signal is substantially increased. The return radiation signal can be further evaluated by appropriate signal processing means e.g. for determining a blood property.

Another advantage is that other noise sources such as stray light from the surroundings are also filtered out which further improves the signal to noise ratio of the return radiation signal.

FIG. 2 is illustrative of a number of signals and the elimination of the fluorescence signal component. Signal 200 is the Raman signal component of return radiation received from the detection volume when an excitation light pulse having a pulse duration of two pico seconds is used. Signal 202 is the fluorescence component of the return radiation signal. With respect to the observation time signal 202 is decaying only slowly and can be approximated as a constant. Signal 204 is the complete return radiation signal which has the Raman and fluorescence signal components, i.e. signals 200 and 202.

Signal 206 is obtained by delaying signal 204 by delay Δt. The delay Δt is larger than the duration of the excitation light pulse and much shorter than the fluorescence life time. In the example considered here the delay Δt is 10 pico seconds. Signal 208 is obtained by subtracting signal 206 from signal 204. The negative portion 210 of difference signal 208 basically only contains Raman contributions. This portion 210 of difference signal 208 is filtered out and used for the spectroscopic analysis.

Delaying of signal 204 can be done either electronically or by optical means. For example the return radiation beam can be split into a first and a second beam. The second beam is optically delayed and the difference signal of the delayed and undelayed beams is detected.

This can be accomplished by using two identical fast photo detectors one of which is positioned a distance L=Δt*c further from the beam splitter than the other, where c is the speed of light. For instance for Δt=10 pico seconds the distance L is 3 millimetres. This way signals 204 and 206 can be measured.

Alternatively the first and the second beams are combined by a second beam splitter. This provides two beams both with a combined signal containing both the delayed and the undelayed return radiation. Again two detectors are used, one in each beam. Both detectors detect the total of the undelayed and the delayed return radiation signal with the difference that the polarity of the second one is inverted at the end of the laser pulse. As a consequence the sum of the two detector signals mainly contains Raman contributions. This will be explained in greater detail by making reference to the FIG. 3:

Return radiation beam 300 which originates from the detection volume is split into beam 302 and beam 304 by beam splitter 306. Beam 304 is reflected on mirror 308 and mirror 310. Both beam 302 and beam 304 are directed on beam splitter 312. The optical path of beam 304 is a distance L longer than the optical path of beam 302 from beam splitter 306 to beam splitter 312.

At beam splitter 312 beam 302 and the delayed beam 304 are recombined which provides two combined beams 314 and 315. Combined beam 314 is directed towards photo detector 316 and combined beam 315 is directed towards the identical photo detector 318. Both detectors have the same optical distance from beam splitter 312.

Photo detector 318 has a control input for changing the polarity of its output signal. The polarity of the output signal of detector 318 is changed at a moment after arrival of the first signal component. Preferably, this polarity change takes place after a time being longer than the excitation pulse duration but smaller than the fluorescence life time. The outputs of photo detectors 316 and 318 are added which provides signal 320. Signal 320 basically only contains Raman contributions and is spectrally analysed.

In FIG. 4 the corresponding signals are shown by way of example. Signal 322 is the output signal of photo detector 316. Signal 322 results from the superposition of beam 302 and delayed beam 304. Signal 324 is the output signal of photo detector 318 when the polarity of photo detector 318 is changed after the pulse duration of the excitation light pulse, i.e. after t=2 pico seconds in the example considered here. When signals 322 and 324 are added this provides signal 326. Signal 326 only contains Raman contributions.

Still another way to eliminate the fluorescence component from the return radiation signal is by electronic gating. For example, the return radiation signal is windowed by means of a window having about the duration of the excitation light pulse and being positioned such that the portion of the return radiation signal containing the Raman peak (cf. signal 200 of FIG. 2) is obtained.

FIG. 5 is a block diagram of a more detailed embodiment for performing blood analysis.

The analysis system includes the monitoring system incorporating a light source (ls) with optical imaging system (Iso) for forming an optical image of the object (obj) to be examined. The optical imaging system (Iso) forms the confocal video microscope. In the present example the object is a piece of skin of the forearm of the patient to be examined.

The analysis system also includes a multi-photon, non-linear or elastic or inelastic scattering optical detection system (ods) for spectroscopic analysis of light generated in the object (obj) by a multi-photon or non-linear optical process. The example shown in FIG. 5 utilises in particular an inelastic Raman scattering detection system (dsy) in the form of a Raman spectroscopy device. The term optical encompasses not only visible light, but also ultraviolet and infrared radiation, specially near-infrared radiation.

The light source of the light source with optical imaging system (Iso) is formed by an 834 nm AlGaAs semiconductor laser whose output power on the object to be examined, that is, the skin, amounts to 15 mW. The infrared monitoring beam (irb) of the 834 nm semiconductor laser is focused in the focal plane in or on the object (obj) by the optical imaging system in the exit focus. The optical imaging system includes a polarising beam splitter (pbs), a rotating reflecting polygon (pgn), lenses (11,12), a scanning mirror (sm) and a microscope objective (mo). The focussed monitoring beam (irb) is moved across the focal plane by rotating the polygon (pgn) and shifting the scanning mirror. The exit facet of the semiconductor laser (ls) lies in the entrance focus.

The semiconductor laser is also capable of illuminating an entrance pinhole in the entrance focus. The optical imaging system conducts the light that is reflected from the focal plane as a return beam, via the polarising beam splitter (pbs), to an avalanche t photodiode (apd). Furthermore, the microscope object (mo) is preceded by a ¼λ-plate so that the polarisation of the return beam is perpendicular to the polarisation of the monitoring beam. An optical display unit utilises the output signal of the avalanche photodiode to form the image (img) of the focal plane in or on the object to be examined, said image being displayed on a monitor.

In practice the optical display unit is a workstation and the image is realised by deriving an electronic video signal from the output signal of the avalanche photodiode by means of the processor of the workstation. This image is used to monitor the spectroscopic examination, notably to excite the target region such that the excitation area falls onto the target region and receiving scattered radiation from the target region.

The Raman spectroscopy device includes an excitation system (exs) which is in this case constructed as an Ar-ion/Ti-sapphire laser which produces the excitation beam in the form of an 850 nm infrared beam (exb). The Ti-sapphire laser is optically pumped with the Ar-ion laser. Light of the Ar-ion laser is suppressed by means of an optical filter (of).

A system of mirrors conducts the excitation beam to the optical coupling unit (oc) and the optical coupling unit conducts the excitation beam along the monitoring beam (irb) after which the microscope objective focuses it in the focal plane at the area of the focus of the monitoring beam. The optical coupling unit (oc) forms the beam combination unit.

The optical coupling unit conducts the excitation beam along the optical main axis of the microscope objective, that is, along the same optical path as the monitoring beam. The Raman scatter is reflected to the entrance of a fibre (fbr) by the optical coupling unit (oc). The Raman scattered infrared light is focussed on the fibre entrance in the detection pinhole by the microscope objective (mo) and a lens (13) in front of the fibre entrance (fbr-I). The fibre entrance itself acts as a detection pinhole.

The optical imaging system establishes the confocal relationship between the entrance focus, where the semiconductor laser (ls) is present, the exit focus at the area of the detail of the object (obj) to be examined, and the detection focus at the pinhole before the avalanche photodiode (apd). The total system has been aligned such that a confocal relationship exists between the exit focus at the area of the detail of the object (obj) to be examined and the fibre entrance (fbr-I).

The fibre (fbr) is connected to the input of a spectrograph (spm) with a detector (phc). The spectrograph with the detector (phc) are incorporated into the detector system (dsy) which records the Raman spectrum for wavelengths that are smaller than approximately 1050 nm.

The output signal of the spectrometer with the detector (phc) represents the Raman spectrum of the Raman scattered infrared light. In practice this Raman spectrum occurs in the wavelength range beyond 730 nm or beyond 860 nm, depending on the excitation wavelength. The signal output of the detector (phc) is connected to a spectrum display unit (spd), for example a workstation which displays the recorded Raman spectrum (spct) on a monitor.

Detector (phc) is a photon counting detector; alternatively a charged coupled device (CCD) detector or streak camera can be used.

A small part of the excitation laser light pulse provided by the excitation system (exs) is split off by glass plate (gp) and fed into a fast photodiode (ph). The output signal of the photodiode (ph) is used as a time reference for the detector (phc) to set the time gate.

It is to be noted that orthogonal polarized spectral imaging (OPSI) can be used instead of confocal video microscopy for imaging; further the Ar-ion/Ti-Saph laser can be exchanged for a diode laser. As a further preferred alternative an excitation wavelength of 785 nm can be used.

FIG. 6 shows an alternative embodiment of apparatus 100. Elements of apparatus 100 that correspond to elements of FIG. 1 are designated by the same reference numerals. Apparatus 100 has an additional dichroic mirror 115 in the light path of return radiation 112. By means of mirror 115 return radiation 112 is split into return radiation signal 116 and return radiation signal 118. Return radiation signal 116 travels along a first optical path before it reaches detector 120. The propagation time from mirror 115 to detector 120 is time T1.

Likewise return radiation signal 118 is received by detector 122. Return radiation signal 118 travels along a second optical path that is longer than the first optical path. This corresponds to an additional time T2 that the return radiation signal 118 requires to reach detector 122. In other words the detection of return radiation signal 118 by detector 122 is delayed by time T2 as compared with the detection of return radiation signal 116 by detector 120.

The detected return radiation signal 116 is multiplied by a scaling factor SF and subtracted from the detected return radiation signal 118 by multiplier 124 and subtracter 126, respectively. The result is return radiation signal 128 that has an improved signal to noise ratio.

In operation return radiation pulse 130 is returned from detection volume 108; after an exitation light pulse 106 (cf. FIG. 1) has been directed towards detection volume 108. The return radiation pulse has signal component 132, signal component 134, and signal component 136. Signal component 132 is caused by some instantaneous scattering mechanism. For example signal component 132 is Raman radiation received from detection volume 108. Signal component 132 has a duration of Δt that is about the same as the pulse duration of excitation light pulse 106.

In addition exitation light pulse 106 may cause luminescence, such as fluorescence, that builds up as long as the exitation light pulse is applied to detection volume 108. This is schematically shown as signal component 134. The decaying luminescence signal component that follows after the end of the excitation light pulse 106 is shown as signal component 136.

The detection of the return radiation pulse starts when return radiation signal 118 reaches detector 122. At this time detector 120 already receives the signal component 136. By subtracting that signal component from return radiation signal 118 signal components 134 and 136 are reduced. For optimal results the optimal scaling factor SF can be determined by experiment or simulation. Under certain conditions a scaling factor in the order of 0.5 works well. Time T2 can for instance be about the same as the length of the excitation light pulse Δt.

It is to be noted that the pulse form of return radiation pulse 130 as shown in FIG. 6 is schematic. Typically signal component 132 will have a profile corresponding to the emission profile of the light source 102.

FIG. 7 shows a block diagram of a further preferred embodiment of apparatus 100. Again the same reference numerals as in FIG. 1 are used for like elements.

In the embodiment of FIG. 7 apparatus 100 has frequency sensitive amplifier 138 that receives return radiation 112. Pulsed light source 102 emits a sequence of exitation light pulses 106 with a repetition frequency of F1. The frequency F2 of the frequency sensitive amplifier 138 is tuned to the frequency F1 such that signal components (cf. signal component 134 and 136) of the return radiation 112 that have different frequencies are suppressed.

For example frequency sensitive amplifier 138 is a so-called lock-in amplifier. This embodiment can be employed with or without a time reference of light source 102 to frequency sensitive amplifier 138.

### LIST OF REFERENCE NUMERALS

100 Apparatus
102 light source
104 spectrometer
106 excitation light pulse
108 detection volume
110 Mirror
112 return radiation
114 filter
115 Dichroic Mirror
116 return radiation signal
118 return radiation signal
120 Detector
122 Detector
124 Multiplier
126 Subtracter
128 return radiation signal
130 return radiation pulse
132 signal component
134 signal component
136 signal component
138 amplifier
200 signal
202 signal
204 signal
206 signal
208 signal
210 portion
300 return radiation beam
302 beam
304 beam
306 beam splitter
308 mirror
310 mirror
312 beam splitter
314 combined beam
315 combined beam
316 photo detector
318 photo detector
320 signal
322 signal
324 signal
326 signal

1. A method of optical spectroscopy comprising:
directing a light pulse having a first pulse duration to a detection volume,
receiving a return radiation signal, the return radiation signal having a first signal component having a second pulse duration, the second pulse duration being substantially similar to the first pulse duration, and one or more second signal components,
reducing of the second signal component in the return radiation signal, and
performing of a spectroscopic analysis of the return radiation signal.

2. The method of claim 1, the first pulse duration being below 10 picoseconds.

3. The method of claim 1, the light pulse being provided by a pulsed laser source.

4. The method of claim 1, wherein the reduction of the second signal component is performed by delaying part of the return radiation signal, thereby providing a delayed return radiation signal and an undelayed return radiation signal.

5. The method of claim 4, wherein the reduction of the second signal component is performed by the steps of:
adding the undelayed return radiation signal and the delayed return radiation signal to provide a first signal,
providing a second signal by adding the undelayed return radiation signal and the delayed return radiation signal, and inverting the resulting signal after arrival of the first signal component,
adding the first and second signals.

6. The method of claim 1, wherein the reduction of the second signal component is performed by time gating using the timing of the light pulse as a reference.

7. The method of claim 1, wherein the reduction of the second signal component is performed by directing a sequence of the light pulses to the detection volume with a first frequency, and using a frequency selective amplifier for reduction of the second signal component.

8. The method of claim 1, wherein the second signal component is a luminescence signal component or background radiation.

9. An apparatus for optical spectroscopy comprising:
means for directing of a light pulse having a first pulse duration to a detection volume, the light pulse causing a return radiation signal having a first signal component and one or more second signal components, the first signal component having a second pulse duration being substantially similar to the first pulse duration,
means for reducing of the second signal component of the return radiation signal,
means for performing of a spectroscopic analysis of the return radiation signal.

10. The apparatus of claim 9, the pulse duration being below 10 pico seconds.

11. The apparatus of claim 9, further comprising a pulsed laser source for providing a sequence of the light pulses, the pulsed laser light source being optically coupled (to the means for reducing of the fluorescence component to provide a time reference.

12. The apparatus of claim 9, further comprising photon counting means for detecting the light pulse in order to provide a time reference for the means for reducing and for receiving of the return radiation to provide the return radiation signal.

13. The apparatus of claim 9, comprising optical means for delaying part of the return radiation in order to provide a delayed return radiation signal for elimination of the second signal component.

14. The apparatus of claim 9, further comprising electronic means for delaying part of the return radiation signal for eliminating of the second signal component.

15. The apparatus of claim 9, wherein the means for performing of a spectroscopic analysis performs Raman spectroscopic analysis.

16. The apparatus of claim 13, further comprising means for multiplication of the undelayed return radiation signal by a scaling factor.

17. The apparatus of claim 14 further comprising means for multiplication of the undelayed return radiation signal by a scaling factor.

18. An apparatus for optical spectroscopy comprising:
a pulsed light source generator that provides an excitation light source directed towards a detection volume;
a means for directing return radiation from the detection volume towards a spectrometer; and
a means for filtering out fluorescence from the return radiation using a time reference provided by the light source.

19. The apparatus of claim 18, wherein the means for filtering out the fluorescence uses the time reference to create a delayed return radiation signal and creates a second signal that is the sum of the delayed return radiation signal and an undelayed return radiation signal; wherein the second signal is used for spectroscopic analysis.

20. The apparatus of claim 19 wherein the second signal includes a negative portion and the negative portion is used for spectroscopic analysis.

21. The apparatus of claim 18, wherein the radiation return signal includes an undelayed radiation return signal and a delayed radiation signal; and wherein the delayed radiation signal and the undelayed radiation signal are combined to form a combined signal.

22. The apparatus of claim 21, wherein the combined signal is split into a first combined signal portion and a second combined signal portion; wherein the apparatus includes means for switching the polarity of one of the first combined signal portion and the second combined signal portion after a time equal to the time reference.

23. The apparatus of claim 22, wherein the switched combined signal portion and the other combined signal portion are added to provide a signal for spectroscopic analysis.
